(19) United States
(12) Patent Application Publication
(10) Pub. No.: US 2026/0161713 A1
(43) Pub. Date: Jun. 11, 2026

(54) GENERATIVE NEURAL NETWORKS WITH INVISIBLE TOKENS

(71) Applicant: GDM Holding LLC, Mountain View, CA (US)

(72) Inventors: Radu Soricut, Manhattan Beach, CA (US); Colton M. Bishop, San Francisco, CA (US)

(21) Appl. No.: 19/417,113

(22) Filed: Dec. 11, 2025

Related U.S. Application Data
(60) Provisional application No. 63/730,950, filed on Dec. 11, 2024.

(51) Int. Cl. G06F 16/903

(52) U.S. Cl. CPC G06F 16/90335

(57) ABSTRACT

Methods, systems, and apparatuses, including computer programs encoded on computer storage media, for processing a network input using a generative neural network to generate an output sequence of output tokens. The system selects each output token from a vocabulary of tokens that includes a plurality of visible tokens and one or more pairs of invisible tokens. The system processes the output sequence of output tokens to generate a final output sequence by removing, from the output sequence, the beginning invisible token, the end invisible token, and each visible token that is between the beginning invisible token and the end invisible token. The system then provides the final output sequence in response to the network input.

### CROSS-REFERENCE TO RELATED APPLICATIONS

This application claims priority of U.S. Provisional Application No. 63/730,950 filed Dec. 11, 2024. The contents of the prior application is incorporated herein by reference in its entirety.

### BACKGROUND

This specification relates to training neural networks to generate output sequences. For example, the output sequences can include text sequences, audio sequences, pixel sequences (that represent an image or a video frame), and so on.

Neural networks are machine learning models that employ one or more layers of nonlinear units to predict an output for a received input. Some neural networks include one or more hidden layers in addition to an output layer. The output of each hidden layer is used as input to the next layer in the network, i.e., another hidden layer or the output layer. Each layer of the network generates an output from a received input in accordance with current values of a respective set of parameters.

### SUMMARY

This specification describes an inference system implemented as computer programs on one or more computers in one or more locations that uses a neural network to perform one or more generative tasks. In some situations, the neural network can thus be referred to as a generative neural network.

Particular embodiments of the subject matter described in this specification can be implemented so as to realize one or more of the following advantages.

Some techniques that generate outputs using generative neural networks often require intermediate processing steps, e.g., generation of intermediate data such as reasoning or grounding data, to produce accurate output sequences in response to network inputs. However, this intermediate data often includes sensitive information, e.g., internal logic or un-sanitized data (e.g., personally identifiable information), that must remain confidential. If a system cannot reliably distinguish and withhold this intermediate data from the final output, it risks leaking sensitive information. To prevent the leakage of such sensitive data, some techniques utilize separate neural networks to generate the intermediate data in a sequestered environment. While this separation makes it easy to identify and withhold the sensitive intermediate data, utilizing multiple neural networks increases computational overhead and network latency due to additional steps and network communication required. Furthermore, relying on external dependencies or separate neural network calls introduces other security risks where the network input and intermediate data content can be intercepted during network communication. Therefore, there is a need for a technique that integrates intermediate data generation directly into an output sequence yet can effectively remove the intermediate data to generate a final output sequence.

This specification describes techniques that can address the aforementioned challenges. That is, the specification describes techniques that can process a network input using a generative neural network to generate an output sequence that includes visible tokens and invisible tokens, and subsequently remove the invisible tokens, along with any visible tokens located between start and end invisible tokens, to generate and provide a final output sequence in response to the network input.

By processing the network input using a generative neural network to generate an output sequence that includes visible tokens and one or more pairs of invisible tokens, the described techniques can integrate intermediate data generation directly into the output sequence of a single model. This reduces computational overhead and network latency by eliminating the need for multiple neural networks or external calls to generate reasoning or grounding data, thereby improving the efficiency of the computing resources and minimizing security risks associated with data transfer between separate models.

By detecting the start invisible token and the end invisible token within the output sequence and removing them (and the tokens therebetween) to generate a final output sequence, the described techniques solve the technical problem of distinguishing between intermediate data and the intended final output. This explicit demarcation is what enables the described techniques to programmatically filter the output sequence to generate a final output sequence that ensures that the final output sequence will not leak sensitive information, such as proprietary logic or private data, to the user interface.

Furthermore, this technique of generating a final output sequence can reduce the volume of data transmitted over communication channels. For example, if this technique of generating a final output sequence occurs at a server that will then send the final output sequence over a communication channel to a user device, sending the final output sequence significantly reduces the volume of data transmitted over the communication channel relative to the original output sequence. Thus, the described techniques conserve network bandwidth and improve transmission efficiency. Additionally, the described techniques can freely utilize intermediate processing, such as extensive chain-of-thought reasoning or detailed prompt expansions, to improve neural network output sequence generation without consuming the network resources required to transmit such data to user devices. Also, by filtering this data at the server side, the security risk of transmitting sensitive data to an untrusted client environment where it could be intercepted or extracted is avoided.

By generating visible tokens conditioned on the set of invisible tokens/intermediate data, the described techniques improve the accuracy and relevance of the final output sequence. The generative neural network can utilize the intermediate data (encapsulated within the invisible tokens) as context to guide the generation of the subsequent visible tokens, allowing for complex reasoning or precise grounding without requiring additional user prompting or external supervision.

The details of one or more embodiments of the subject matter of this specification are set forth in the accompanying drawings and the description below.

According to a first aspect there is provided a method performed by one or more computers that comprises receiving a network input; processing the network input using a generative neural network to generate an output sequence of output tokens, wherein each output token is selected from a vocabulary of tokens that includes a plurality of visible tokens and one or more pairs of invisible tokens, each pair of invisible tokens comprising a respective beginning invisible token and a respective end invisible token; processing the output sequence of output tokens to generate a final output sequence, comprising: determining that the output sequence includes a beginning invisible token from one of the pairs followed by an end invisible token from the same pair; and in response, removing, from the output sequence, the beginning invisible token, the end invisible token, and each visible token that is between the beginning invisible token and the end invisible token in the output sequence; and providing the final output sequence in response to the network input.

In some cases, the generative neural network comprises an auto-regressive neural network that auto-regressively generates tokens from the vocabulary, and wherein the output sequence comprises visible tokens that are after the end invisible token in the output sequence and that are generated conditioned on the visible tokens that are between the beginning invisible token and the end invisible token in the output sequence.

In some cases, the visible tokens comprise text tokens that represent text data.

In some cases, the visible tokens comprise image tokens that represent image data.

In some cases, the visible tokens comprise audio tokens that represent audio data.

In some cases, the network input is received from a user device, the set of one or more computers are remote from the user device, and providing the final output sequence in response to the network input comprises providing the final output sequence to the user device.

In some cases, removing, from the output sequence, the beginning invisible token, the end invisible token, and each visible token that is between the beginning invisible token and the end invisible token in the output sequence is performed by the set of one or more computers prior to providing the final output sequence to the user device, such that the tokens between the beginning invisible token and the end invisible token are not transmitted to the user device.

In some cases, the network input is received as input from a user device, the set of one or more computers includes only the user device, and providing the final output sequence in response to the network input comprises providing the final output sequence for presentation on the user device.

In some cases, the set of one or more computers includes a server remote from a user device and the user device, the server performs the processing of the network input using the generative neural network to generate the output sequence and transmits the output sequence to the user device, and the user device performs the processing of the output sequence to generate the final output sequence by removing the beginning invisible token, the end invisible token, and each visible token that is between the beginning invisible token and the end invisible token.

In some cases, the network input comprises an initial prompt that characterizes a media item to be generated by the generative neural network, and wherein the tokens between the beginning invisible token and end invisible token represent an expanded prompt for generating the media item.

In some cases, the media item is an image, a video, or an audio sample.

In some cases, the generative neural network is configured to generate the media item conditioned on the tokens between the beginning invisible token and end invisible token, and wherein the method further comprises: providing the media item in response to the network input.

In some cases, the network input comprises a query, wherein the tokens between the beginning invisible token and end invisible token represent intermediate data for generating a response to the query, and wherein the output sequence further comprises visible tokens that follow the end invisible token that represent the response to the query generated conditioned on the intermediate data.

In some cases, the network input further comprises an image or a video and the query is a query about the image or video.

In some cases, the intermediate data is grounding data specifying locations in the image or video of one or more objects.

In some cases, the intermediate data is a reasoning output.

In some cases, the vocabulary of tokens includes a plurality of distinct pairs of invisible tokens, and wherein removing, from the output sequence, the beginning invisible token, the end invisible token, and each visible token that is between the beginning invisible token and the end invisible token in the output sequence is performed according to a specific handling action determined based on an identity of the pair of invisible tokens included in the output sequence.

In some cases, the plurality of distinct pairs of invisible tokens includes a first pair associated with a first handling action and a second pair associated with a second handling action that is different from the first handling action.

According to a second aspect there is provided a method for training a generative neural network performed by one or more computers that includes receiving a training dataset comprising a plurality of training examples, wherein each training example includes a training network input and a target sequence of visible tokens; obtaining, for each training example, a sequence of intermediate data tokens derived from the training network input and the target sequence of visible tokens; generating, for each training example, a composite target output sequence by inserting a beginning invisible token from a pair of invisible tokens before the sequence of intermediate data tokens and an end invisible token from the pair of invisible tokens after the sequence of intermediate data tokens, and appending the target sequence of visible tokens after the end invisible token; and training the generative neural network through supervised fine tuning on, for each training example, the training network input in the training example and the composite target output sequence for the training example.

In some cases of the second aspect, training the generative neural network through supervised fine tuning on, for each training example, the training network input in the training example and the composite target output sequence for the training example comprises training the generative neural network on an objective that measures, for each training example, a likelihood assigned by the generative neural network to tokens in the composite target output sequence for the training example by processing the training network input in the training example.

According to a third aspect there is provided the methods of the first aspect or second aspect performed by a system comprising: one or more computers; and one or more storage devices communicatively coupled to the one or more computers, wherein the one or more storage devices store instructions that, when executed by the one or more computers, cause the one or more computers to perform the respective operations of the respective method.

According to a fourth aspect there is provided the methods of the first aspect or second aspect performed by one or more non-transitory computer storage media storing instructions that when executed by one or more computers cause the one or more computers to perform the respective operations of the respective method.

Other features, aspects, and advantages of the subject matter will become apparent from the description, the drawings, and the claims.

### BRIEF DESCRIPTION OF THE DRAWINGS

FIG. 1 shows an inference system.

FIG. 2A is a flow diagram of an example process for providing a final output sequence in response to a network input.

FIG. 2B shows an example of providing a final output sequence in response to a network input.

FIG. 2C shows an example of providing a final output sequence in response to a network input.

FIG. 2D shows an example of providing a final output sequence in response to a network input.

FIG. 3 is a flow diagram of an example process for finetuning a generative neural network to use invisible tokens.

Like reference numbers and designations in the various drawings indicate like elements.

### DETAILED DESCRIPTION OF THE DRAWINGS

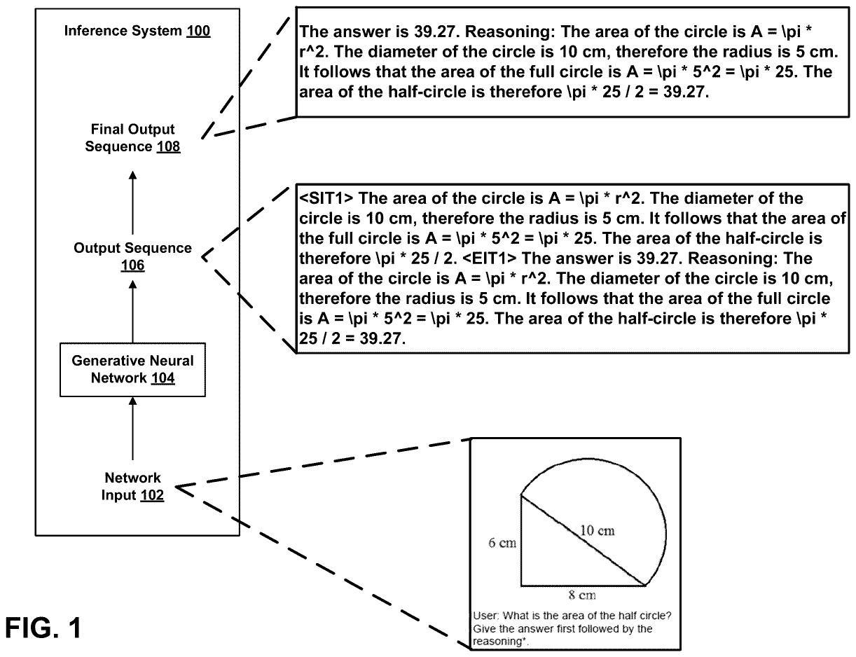

FIG. 1 shows an inference system 100. The system 100 is an example of a system implemented as computer programs on one or more computers in one or more locations, in which the systems, components, and techniques described below can be implemented.

The system 100 can process a network input 102 using a generative neural network 104 to generate an output sequence 106 that includes visible tokens and invisible tokens, and subsequently remove the invisible tokens, along with any visible tokens located between start and end invisible tokens, to generate and provide a final output sequence 108 in response to the network input 102.

In particular, the system 100 receives a network input 102 to be processed by the generative neural network 104.

The system 100 processes the network input 102 using a generative neural network 104 to generate an output sequence 106 of output tokens, wherein each output token is selected from a vocabulary of tokens that includes a plurality of visible tokens and one or more pairs of invisible tokens. Each pair of invisible tokens includes a respective beginning invisible token and a respective end invisible token. “Visible” tokens are tokens that are generated and that can be provided as output from the system 100, e.g., text tokens, image tokens, audio tokens, and so on. Examples of visible tokens that can be included in the vocabulary are described below.

The system 100 processes the output sequence 106 of output tokens to generate a final output sequence 108. As part of this, the system 100 determines that the output sequence 106 includes a beginning invisible token from one of the pairs followed by an end invisible token from the same pair.

In response, the system 100 removes, from the output sequence 106, the beginning invisible token, the end invisible token, and each visible token that is between the beginning invisible token and the end invisible token in the output sequence 106.

The system 100 then provides the final output sequence 108 in response to the network input 102. Thus, although the generative neural network 104 generated the invisible tokens and the tokens between the pair of invisible tokens, the system 100 does not provide these as part of the final output sequence 108. Instead, these tokens are only used to condition and improve the generation of the other tokens that are provided as part of the final output sequence 108.

In some cases, there is a single pair of invisible tokens in the vocabulary. In some other cases, there are multiple pairs of invisible tokens in the vocabulary. In these other cases, different pairs of invisible tokens can be associated with, e.g., different levels of sensitivity or importance, and their presence can therefore trigger different actions to be performed by the system.

For example, the system 100 can store a mapping or policy configuration that associates specific invisible token pairs with specific handling rules. For example, a first pair (e.g., Tier 0) may be associated with a rule to transmit the tokens to a client device but flag them for non-display by the user interface; a second pair (e.g., Tier 1) may be associated with a rule to strictly remove the tokens at the server side before transmission; and a third pair (e.g., Tier 2) may be associated with a rule to encrypt the tokens immediately upon generation or process them only within a secure enclave.

For example, the presence of one pair of invisible tokens can trigger an indication to the system 100 to not provide the tokens as part of the final output sequence 108 but to allow a user device to separately view the tokens that are in between the pair. As another example, the presence of another pair of invisible tokens can trigger an indication to the system 100 to not provide the tokens that are in between the pair to any remote or user device, even in response to a request. The pair of invisible tokens serve as markers to indicate special handing of the tokens in between the markers. As discussed, this can include the exclusion of the tokens from the final output sequence or that the tokens are to be initially hidden from display.

Description of examples of the generative neural network 104 now follows. The generative neural network 104 is a neural network having parameters and that can be configured through training to process an input sequence that is made up of tokens from a vocabulary in accordance with the parameters to generate, based on the input sequence, an output sequence for a generative task that is made up of tokens from the vocabulary. For example, the input sequence can include a prompt that provides context for the output sequence.

After training, the inference system or another system can deploy the generative neural network 104 on one or more computing devices to perform inference for the one or more generative tasks, i.e., to generate new output sequences for the generative tasks based on new input sequences.

The vocabulary of tokens can include any of a variety of tokens that represent text symbols or other symbols. For example, the vocabulary of tokens can include one or more of characters, sub-words, words, punctuation marks, numbers, or other symbols that appear in a corpus of natural language text and/or computer code.

Additionally, or alternatively, the vocabulary of tokens can include tokens that can represent data other than text. For example, the vocabulary of tokens can include image tokens that represent a discrete set of image patch embeddings of an image that can be generated by an image encoder neural network based on processing the image patches of the image. As another example, the vocabulary of tokens can include audio tokens that represent code vectors in a codebook of a quantizer, e.g., a residual vector quantizer.

In some implementations, the generative neural network 104 can be configured as an auto-regressive language model neural network. The language model neural network is referred to as an auto-regressive neural network when the language model neural network auto-regressively generates an output sequence of tokens by generating each particular token in the output sequence conditioned on a current input sequence that includes any (e.g. all) tokens that precede the particular token in the output sequence, i.e., tokens that have already been generated for any previous positions in the output sequence that precede the particular position of the particular token, and the input sequence. An auto-regressive neural network sequentially generates one output token at a time.

For example, the current input sequence when generating a token at any given position in the output sequence can include the input sequence and the tokens at any preceding positions that precede the given position in the output sequence. As a particular example, the current input sequence can include the input sequence followed by the tokens at any (e.g., all) preceding positions that precede the given position in the output sequence. Optionally, the input sequence and the current output sequence can be separated by one or more predetermined tokens within the current input sequence.

More specifically, to generate a particular token at a particular position within an output sequence, the generative neural network 104 can process the current input sequence to generate a score distribution, e.g., a probability distribution, that assigns a respective score, e.g., a respective probability, to each token in the vocabulary of tokens. The generative neural network 104 can then select, as the particular token, a token from the vocabulary using the score distribution. For example, the generative neural network 104 can greedily select the highest-scoring token or can sample, e.g., using nucleus sampling or another sampling technique, a token from the distribution.

As a particular example, the generative neural network 104 can be or comprise an auto-regressive Transformer-based neural network that includes (i) a sequence comprising a plurality of attention blocks that each apply a self-attention operation and (ii) an output subnetwork that processes an output of the last attention block to generate the score distribution.

The generative neural network 104 can have any of a variety of Transformer-based language model neural network architectures. Examples of such neural network architectures include those described in Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020; Aakanksha Chowdhery, et al. PaLM: Scaling Language Modeling with Pathways, arXiv preprint arXiv: 2204.02311; Rohan Anil, et al. Palm 2 technical report. arXiv preprint arXiv: 2305.10403, 2023; and Gemini Team, et al. Gemini: a family of highly capable multimodal models. arXiv preprint arXiv: 2312.11805 (2023).

Generally, however, the Transformer-based language model neural network includes a sequence of attention blocks, and, during the processing of a given input sequence, each attention block in the sequence receives a respective input hidden state for each input token in the given input sequence. The attention block then updates at least the hidden state for the last token in a given input sequence at least in part by applying self-attention to generate a respective output hidden state for the last token. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

As an example, the generative neural network 104 can generate text sequences, i.e., each output sequence generated by the generative neural network 104 is a sequence of text tokens from a vocabulary of text tokens that includes, e.g., one or more of characters, sub-words, words, punctuation marks, numbers, or other symbols that appear in natural language text. For example, the inference system 100 can use the generative neural network 104 to generate text sequences and provide the text sequences for presentation to users.

As another example, the generative neural network 104 can generate images or videos that have multiple frames (where each frame is an image) by generating images, e.g., either as sequences of pixels or through an iterative denoising process. For example, the output sequence generated by the generative neural network includes a plurality of color values for pixels in an image arranged according to a specified order. As another example, the output sequence generated by the generative neural network includes a plurality of tokens that represent image patch embeddings of an image which can then be processed by a decoder neural network to generate the image. For example, the inference system 100 can use the generative neural network 104 to generate an image or a video conditioned on an input sequence that includes a text description of the content of the image or the video. For example, the text description can describe the objects that are to be present in the generated image or video.

As another example, the input sequence is a sequence of text and the output sequence is another sequence of text, e.g., a completion of the input sequence of text, a paraphrase of the input sequence of text, a response to a question posed in the input sequence, or a sequence of text that is about a topic specified by the input sequence of text. As another example, the input sequence can be an input other than text, e.g., a plurality of pixels included in an image, and the output sequence can be a text sequence that describes the input. For example, the text sequence can describe the objects that are present in the input.

As another example, the input sequence represents data to be compressed, e.g., image data, text data, audio data, or any other type of data; and the output sequence is a compressed version of the data. The tokens included in the output sequence can include any representation of compressed data, e.g., symbols or embeddings to be decoded by a respective neural network.

As a particular example, the inference system 100 can be part of a dialog system and the input sequence can include audio or text from the most recent conversational turn submitted by a user of the dialog system during the dialog while the output sequence is the next turn in the conversation, e.g., either text or audio that is a response to the most recent conversational turn. Optionally, the input sequence can also include one or more historical conversational turns that occurred earlier in the conversation.

As another particular example, the inference system 100 can be part of a machine translation system and the input sequence can include text in a source language while the output sequence can include text in a target language that is a translation of the source text into the target language.

As another particular example, the inference system 100 can be part of a natural language processing system. For example, if the input sequence is a sequence of words in an original language, e.g., a sentence or phrase, the output sequence can be a summary of the input sequence in the original language, i.e., a sequence that has fewer words than the input sequence but that retains the essential meaning of the input sequence. As another example, if the input sequence is a sequence of words that form a question, the output sequence can be a sequence of words that form an answer to the question.

As another particular example, the inference system 100 can be part of a computer-assisted medical diagnosis system. For example, the input sequence can be a sequence of data from an electronic medical record and the output sequences can each be a sequence of predicted treatments.

As another particular example, the inference system 100 can be part of a computer code generation system and the input sequence can include a text description of a desired piece of code or a snippet of computer code in a programming language and the output sequence can include computer code, e.g., a snippet of code that is described by the input sequence or a snippet of code that follows the input sequence in a computer program.

As another particular example, the inference system 100 can be part of a multi-modal system that processes multi-modal input sequences, e.g., both text and image input sequences, or both text and audio input sequences, and generates the output sequences that are either in a single data modality or in multiple data modalities, e.g., text and image output sequences, or text and audio output sequences. Examples of such multi-modal systems include an image captioning system, a text-based image search system, an image-based question answering system, and so on.

As another particular example, the inference system 100 can be part of or associated with a robotic control system, i.e., a system for controlling one or more mechanical agents. The input sequence can comprise a natural language description of one or more tasks for a the one or more mechanical agents and the output sequence can comprise a sequence of instructions (e.g., joint angles, torques, velocities, etc.) for the one or more mechanical agents that cause the one or more mechanical agents to perform the one or more tasks described in the input sequence.

In a similar example, the inference system 100 can be part of or associated with a control system in a manufacturing environment for manufacturing a product, i.e., a system for controlling a manufacturing unit or a machine that operates to manufacture the product. In another similar example, the inference system can be part of or associated with a control system in a service facility comprising a plurality of items of electronic equipment.

As another particular example, the inference system 100 can be part of or associated with a search system that facilitates searching of resources on the Internet. A resource can be any data that can be provided over the Internet. A resource can be identified by a resource address that is associated with the resource. Resources include web pages, word processing documents, portable document format (PDF) documents, images, video, and news feed sources, to name a few.

In this particular example, the search system can receive search queries submitted by client devices and, in response, identify resources that are relevant to the search query in the form of search results and return the search results to the user devices in search results pages. A search result page can include search result data generated by the search system that identifies a resource responsive to a search query, and includes a link to the resource. The search result page can additionally include a result in the form of an output sequence that is generated by the inference system based on an input sequence derived from the search query.

The generative neural network 104 is typically trained using a multi-stage approach: a pre-training stage followed by a fine-tuning stage. These stages can be performed by the system 100, another system (e.g., a training system), or both. As an example, the system 100 can receive data specifying a pre-trained generative neural network from another system (e.g., a training system), and then perform the fine-tuning of the pre-trained generative neural network.

In the pre-training stage, the generative neural network is pre-trained by the inference system 100 or another system based on optimizing one or more unsupervised or self-supervised objective functions, e.g., a maximum-likelihood objective function, on one or more large datasets and then, in some cases, adjusted to the generative tasks, which can include any combination of one or more of the generative tasks mentioned below and possibly other tasks, through fine-tuning adaptation based on supervised learning, reinforcement learning from human feedback (RLHF), reinforcement learning from AI feedback (RLAIF), prompt tuning, instruction tuning, and the like, that use different training objectives, different datasets, or both.

The one or more large datasets used during the pre-training stage can include a large dataset of text in one or more natural languages, e.g., text that is publicly available from the Internet or another text corpus, a large dataset of computer code in one or more programming languages, e.g., Python, C++, C #, Java, Ruby, PHP, and so on, e.g., computer code that is publicly available from the Internet or another code repository, a large dataset of audio samples, e.g., audio recordings or waveforms that represent the audio recordings, a large dataset of images where each image includes an array of pixels, a large dataset of videos where each video includes a temporal sequence of frames, or a large multi-modal dataset that includes a combination of two or more of these datasets.

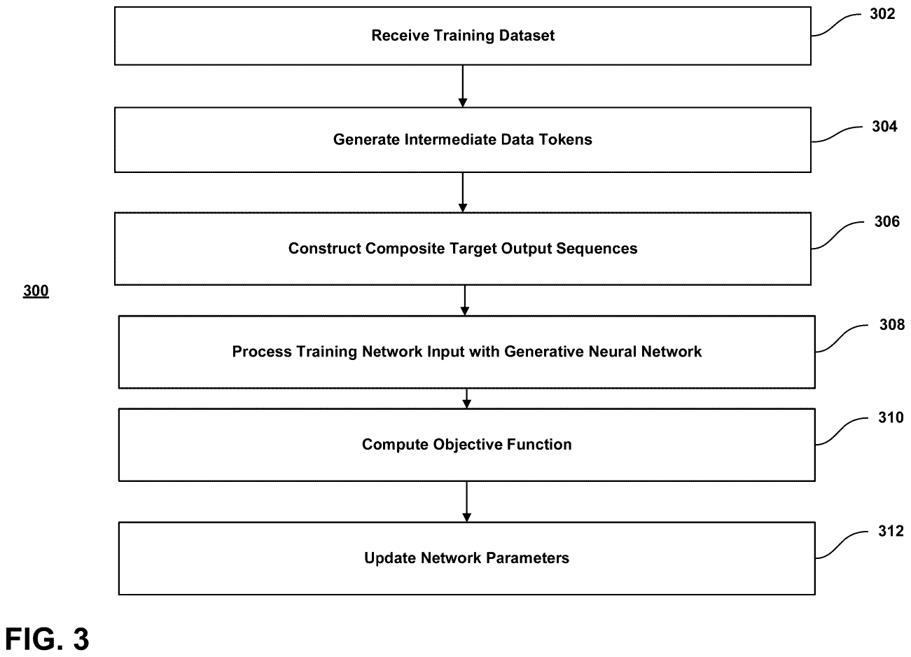

Further details of finetuning the generative neural network 104 are described below with reference to FIG. 3

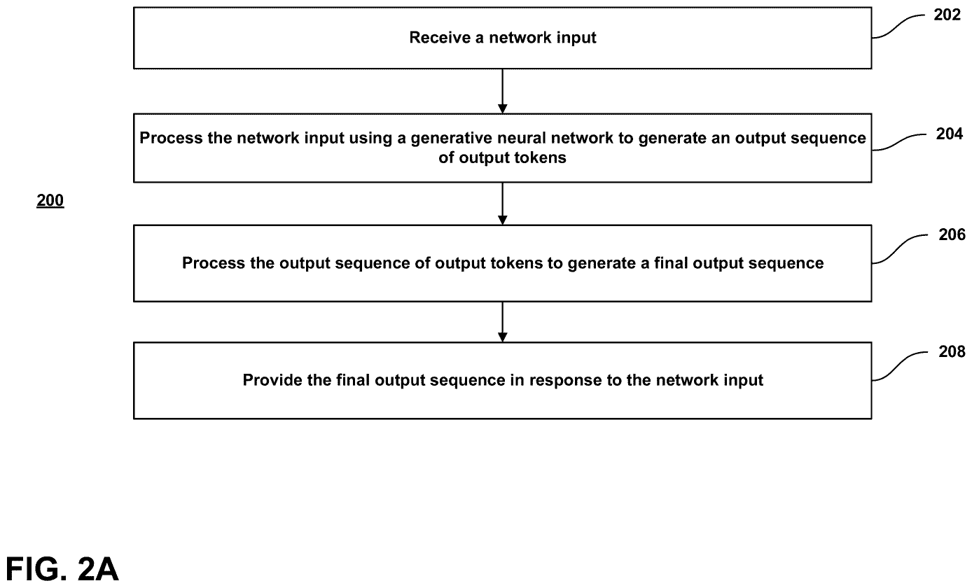

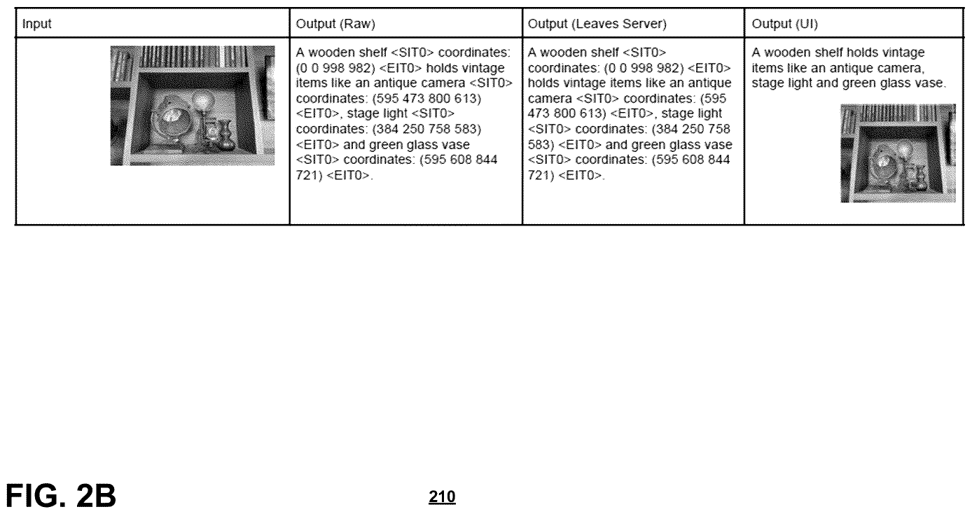

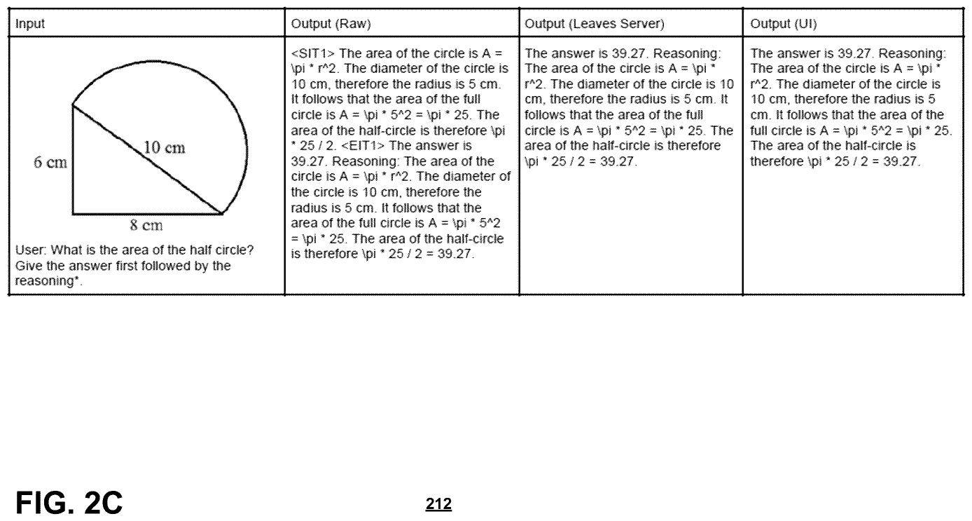

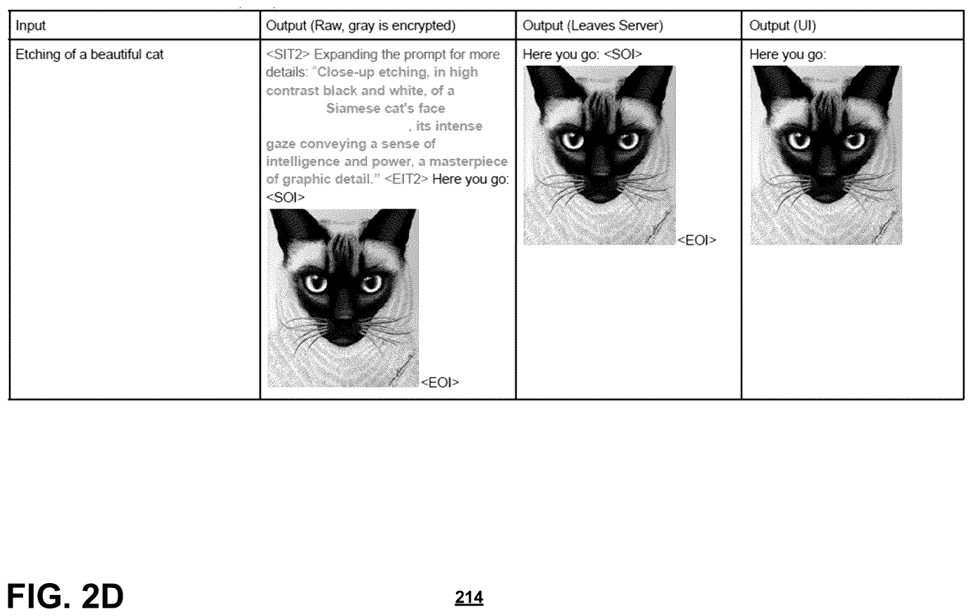

FIG. 2A is a flow diagram of an example process 200 for providing a final output sequence in response to a network input. For convenience, the process 200 will be described as being performed by a system of one or more computers located in one or more locations. For example, an inference system, e.g., the inference system 100 of FIG. 1, appropriately programmed in accordance with this specification, can perform the process 200.

The system receives a network input (step 202).

As described above, the network input can be a sequence of text, an image, a video, a sequence of audio data, or any multi-modal combination of these.

In some cases, the network input can include a query, e.g., a natural language question or a search query.

In some cases, the network input further includes an image or a video and the query is a query about the image or video. For example, the network input can include an image containing fruit and the query may ask “Is the apple on the right or on the left of the strawberry?”

In some cases, the network input includes an initial prompt that characterizes a media item to be generated (e.g., by a generative neural network, e.g., generative neural network 104). The prompt can include a text description of the desired content, such as “Depict a cat dancing at a party” or “Show me a rare species of deer”. The media item is an image, a video, or an audio sample.

The system can receive the network input from any of a variety of appropriate sources, such as a user device interacting with the system over a data communication network or a user device executing the system locally.

In some cases, the system receives the network input from a user device and the one or more computers of the system can be remote from the user device.

The user device can be any kind of user device, such as any user device that includes a display for presenting information to a user and an input device, such as a keyboard, touchscreen, or microphone, for receiving user input. In some implementations, the user device is a mobile device.

For example, the system can be implemented on one or more servers remote from the user device, and can receive the network input over a communication network (e.g., the Internet) from the user device.

In some cases, the system receives the network input as input from a user device and the set of one or more computers of the system includes only the user device.

For example, the system can include only the user device, such that the processing of the network input is performed locally on the user device (e.g., a smartphone).

The system processes the network input using a generative neural network to generate an output sequence of output tokens (step 204).

As described above the generative neural network can have any of a variety of architectures and configurations, e.g., an architecture that includes fully connected layers, convolutional layers, recurrent layers, attention-based layers, and so on, as is appropriate such that the system can use it to process a network input to generate an output sequence.

In some implementations, the generative neural network includes an auto-regressive neural network that auto-regressively generates tokens from the vocabulary. In these implementations, the output sequence includes visible tokens that are after the end invisible token in the output sequence and that are generated conditioned on the visible tokens that are between the beginning invisible token and the end invisible token in the output sequence.

Each output token in the output sequence can be selected from a vocabulary of tokens that includes a plurality of visible tokens and one or more pairs of invisible tokens. The one or more pairs of invisible tokens each include a respective beginning invisible token and a respective end invisible token.

Visible tokens can include text tokens that represent text (e.g., characters, sub-words, words, or punctuation marks), image tokens that represent image data (e.g., discrete image patch embeddings), or audio tokens that represent audio data (e.g., code vectors in a codebook of a quantizer).

In some cases, tokens between the beginning invisible token and end invisible token can represent auxiliary information generated by the generative neural network, such as an expanded description of the network input or intermediate reasoning data derived from the network input.

In some implementations, the network input includes an initial prompt that characterizes a media item to be generated by the generative neural network, and the tokens between the beginning invisible token and end invisible token represent an expanded prompt for generating the media item. The media item can be an image, a video, or an audio sample.

For example, if the network input is a brief or underspecified text description like “Etching of a cat,” the tokens between the beginning and end invisible tokens can represent a detailed, descriptive prompt generated by the generative neural network, such as “Close-up etching, in high contrast black and white, of a Siamese cat's face . . .”

In some cases, in these implementations, the generative neural network can be configured to generate the media item conditioned on the tokens between the beginning invisible token and end invisible token. As an example, continuing the example above, the generative neural network can utilize the invisible detailed prompt (the “expanded prompt”) to generate the specific image tokens representing the etching.

In some implementations, when the network input includes a query, the tokens between the beginning invisible token and end invisible token represent intermediate data for generating a response to a query (e.g., a query included in the network input), and the output sequence further includes visible tokens that follow the end invisible token that represent the response to the query generated conditioned on the intermediate data.

In some implementations, when the network input includes an image or a video and a query about the image or video, the intermediate data is grounding data specifying locations in the image or video of one or more objects.

For example, if the network input includes an image of fruit and a query asking, “Is the apple on the right or on the left of the strawberry?”, the intermediate data can include bounding box coordinates for the objects (e.g., “Apple is at position [ymin xmin ymax xmax] . . . Strawberry is at position [ymin xmin ymax xmax] . . . ”). The generative neural network generates the output sequence based on these invisible coordinates to accurately generate the response “Apple is on the right side of the strawberry”.

In some implementations, when the network input includes an image or a video and a query about the image or video, the intermediate data is a reasoning output.

For example, if the network input includes an image depicting a geometry problem (e.g., a circle with a diameter of 10 cm) and a query asking, “What is the area of the half circle?”, the intermediate data can include chain-of-thought reasoning steps derived from the image data (e.g., “The diameter of the circle is 10 cm, therefore the radius is 5 cm. It follows that the area of the full circle is . . . The area of the half-circle is . . .”).

The system processes the output sequence of output tokens to generate a final output sequence (step 206).

More specifically, the system determines that the output sequence includes a beginning invisible token from one of the pairs followed by an end invisible token from the same pair.

The system then, in response, removes, from the output sequence, the beginning invisible token, the end invisible token, and each visible token that is between the beginning invisible token and the end invisible token in the output sequence.

As an example, if the output sequence is “<SIT> The area of the circle is . . . <EIT> The answer is 39.27”, the system identifies and deletes the sequence starting at beginning invisible token “<SIT>” and ending at the end invisible token “<EIT>”. As a result, the final output sequence include sonly the visible tokens “The answer is 39.27”.

The system provides the final output sequence in response to the network input (step 208).

In some cases, when the system receives the network input from a user device and the set of one or more computers are remote from the user device, the system provides the final output sequence in response to the network input by providing the final output sequence to the user device.

For example, the system acts as a server that transmits the final output sequence (with invisible tokens already removed) over a communication network to a client application on the user device for display. By performing this removal at the server prior to transmission, the system significantly reduces the volume of data transmitted over the communication channel, thereby conserving network bandwidth and reducing transmission latency relative to transmitting the full output sequence.

In some cases, when the system receives the network input as input from a user device and the set of one or more computers includes only the user device, the system provides the final output sequence in response to the network input by providing the final output sequence for presentation on the user device.

For example, the user device (e.g., a smartphone) executes the generative neural network locally, generates the output sequence, performs the removal of the invisible tokens within the device's local memory, and renders the resulting final output sequence on the device's display screen. This local processing to generate the output sequence followed by generating and providing the final output sequence enables the generative neural network to utilize extensive intermediate reasoning (e.g., intermediate data) to improve the accuracy of the generated output sequence. Yet, by providing the final output sequence for presentation on the user device instead of the original output sequence, the system avoids cluttering the user interface. This is particularly useful where the user device has limited screen space such as a mobile device.

In some cases, the set of one or more computers includes a server remote from a user device and the user device. The server can perform the processing of the network input using the generative neural network to generate the output sequence and transmit the output sequence to the user device. At the user device, the user device can perform the processing of the output sequence to generate the final output sequence by removing the beginning invisible token, the end invisible token, and each visible token that is between the beginning invisible token and the end invisible token. The user device can then provide the final output sequence in response to the network input. The removal can be performed by the user device prior to providing the final output sequence, e.g., for presentation on the user device, such that the tokens between the beginning invisible token and the end invisible token are not visually displayed by the user device.

In some cases, when the generative neural network is configured to generate the media item conditioned on the tokens between the beginning invisible token and end invisible token, when the system provides the final output sequence in response to the network input, the system provides the media item in response to the network input.

For example, if the network input is a user request “Draw a big deer,” the generative neural network can generate invisible tokens representing the expanded prompt “A deer standing in a snowy forest with large antlers, cinematic lighting.” The generative neural network then generates the visible image tokens representing the deer conditioned on this invisible description. The system then removes the invisible text to generate the final output sequence and provides the generated image to the user.

As described above, the system can be configured in different implementations regarding the specific handling of invisible tokens.

In some implementations, the vocabulary includes only a single pair of invisible tokens. For example, the system can be configured to perform a uniform action (e.g., removing the tokens to generate the final output sequence) whenever the single pair is detected, regardless of the specific content contained between the tokens.

In some other implementations, the vocabulary includes multiple distinct pairs of invisible tokens (e.g., <SIT0>/<EIT0>, <SIT1>/<EIT1>, etc.), each corresponding to a different “tier” of invisibility that triggers a distinct action by the system.

For example, for a first tier (e.g., “Tier 0”), the presence of the corresponding pair of invisible tokens triggers an action to include the tokens in the transmission to the user device but flag them for non-display. In this case, providing the final output sequence includes transmitting the output sequence including the invisible tokens to the user device, where the user device is configured to strip the tokens from the user interface. For a second tier (e.g., “Tier 1”), the presence of the corresponding pair of invisible tokens triggers an action to strictly remove the tokens at a server system. In this case, providing the final output sequence includes removing the invisible tokens (e.g., intermediate chain-of-thought reasoning) at the server prior to transmitting the final output sequence to the user device. This can include system data or system logic that is not intended for display to the user. For a third tier (e.g., “Tier 2”), the presence of the corresponding pair of invisible tokens triggers a security-enhanced action, such as encrypting the tokens immediately upon generation or processing them only within a trusted execution environment.

FIG. 2B shows an example 210 of providing a final output sequence in response to a network input.

More specifically, example 210 shows the processing flow of the system for a network input (i.e., “Input”) that includes an image of a shelf with various objects. The system generates an output sequence (i.e., “Output (Raw)”) using the generative neural network, which contains visible tokens (e.g., “A wooden shelf . . . holds vintage items”) interleaved with invisible tokens demarcated by beginning invisible token (<SIT0>) and end invisible token (<EIT0>). In this example a specific pair of invisible tokens (e.g., <SIT0> and <EIT0>) is associated with a specific level of sensitivity (e.g., ‘Tier 0’ as described above). In this example, the invisible tokens encapsulate visible tokens that represent grounding data, specifically bounding box coordinates (e.g., coordinates: (0 0 998 982)). The example 210 illustrates a specific implementation of the system where the output sequence “Output (Leaves Server)” is transmitted to a user device, where the system further processes it to generate the final output sequence “Output (UI)”. The final output sequence provided to the user has the invisible coordinate tokens removed, leaving only the descriptive text and the referenced image.

FIG. 2C shows an example 212 of providing a final output sequence in response to a network input.

More specifically, example 212 shows the processing flow of the system for a network input (i.e., “Input”) that includes an image depicting a geometry problem (a semi-circle with defined dimensions) and a text query asking “What is the area of the half circle? Give the answer first followed by the reasoning”. The system generates an output sequence (i.e., “Output (Raw)”) using the generative neural network, which contains a sequence of tokens representing intermediate reasoning data (e.g., “The area of the circle is . . . therefore the radius is 5 cm . . .”) demarcated by a beginning invisible token (<SIT1>) and an end invisible token (<EIT1>). In this example a specific pair of invisible tokens (e.g., <SIT1> and <EIT1>) is associated with a specific level of sensitivity (e.g., ‘Tier 1’ as described above). This invisible sequence is followed by visible tokens representing the specific response requested (e.g., “The answer is 39.27 . . .”). The example 212 illustrates a specific implementation of the system where the final output sequence “Output (Leaves Server)” is generated by removing the invisible tokens at the server side prior to transmission. Consequently, the “Output (UI)” presented on the user device comprises only the final calculated answer followed by the visible reasoning.

FIG. 2D shows an example 214 of providing a final output sequence in response to a network input.

More specifically, example 214 shows the processing flow of the system for a network input (i.e., “Input”) comprising a short text prompt “Etching of a cat”. The system generates an output sequence (i.e., “Output (Raw, gray is encrypted)”) using the generative neural network. This sequence includes a beginning invisible token (<SIT2>) followed by tokens representing an expanded prompt (e.g., “Expanding the prompt for more details: ‘Close-up etching, in high contrast black and white . . .’”) and an end invisible token (<EIT2>). In this example a specific pair of invisible tokens (e.g., <SIT2> and <EIT2>) is associated with a specific level of sensitivity (e.g., ‘Tier 2’ as described above). In this example, the tokens between the invisible delimiters are encrypted (represented by gray text) to prevent leakage of the prompt engineering logic. Following the invisible segment, the sequence includes visible text tokens (e.g., “Here you go:”) and visible image tokens representing the generated media item (the image of the cat). The system processes this output sequence to generate the final output sequence “Output (Leaves Server)” by removing the encrypted invisible segment entirely. Finally, the system displays the visible text and the generated image of the final output sequence “Output (UI)” on the user device.

FIG. 3 is a flow diagram of an example process 300 for finetuning a generative neural network to use invisible tokens. For convenience, the process 300 will be described as being performed by a system of one or more computers located in one or more locations. For example, an inference system, e.g., the inference system 100 of FIG. 1, appropriately programmed in accordance with this specification, can perform the process 300.

The system receives a training dataset (step 302). The training dataset includes a plurality of training examples, where each training example includes a training network input (e.g., any of the above described types of network inputs, e.g., a network input including a query and or image) and a target sequence of visible tokens (e.g., a text response or generated image tokens).

The system generates intermediate data tokens (step 304). For each training example, the system generates a sequence of tokens representing intermediate data derived from the training network input and the target visible tokens. This intermediate data can include any type of visible tokens found between invisible tokens in an output sequence as described above, e.g., reasoning output, grounding data specifying locations in an image, or an expanded prompt.

For example, to generate intermediate data representing an expanded prompt, the system can utilize a teacher model (e.g., another generative neural network) or a few-shot prompting strategy with the system's generative neural network to generate intermediate data tokens as an output sequence that is grounded on both the training network input (e.g., a short user prompt) and the target visible tokens (e.g., a target image).

The system constructs composite target output sequences (step 306). The system modifies the target sequence for each training example by: (a) inserting a beginning invisible token from a pair of invisible tokens before the tokens representing the intermediate data; (b) inserting an end invisible token from the same pair after the tokens representing the intermediate data; and (c) positioning these tokens such that the subsequent visible tokens follow the end invisible token.

For example, if the generated intermediate data is a reasoning sequence such as “The radius is 5 . . . ” and the target visible tokens are the answer “39.27”, the system constructs a composite target sequence formatted as: <SIT 1> The radius is 5 . . . <EIT 1 39.27.

The system processes the training network input with the generative neural network (step 308). The system processes the network input using the generative neural network (e.g., using an auto-regressive generative neural network) to generate a predicted output sequence of output tokens. Each token in the output sequence is selected from a vocabulary of tokens that includes the plurality of visible tokens and the one or more pairs of invisible tokens.

The system computes an objective function (step 310). To compute the objective function, for each training example, the system calculates a loss value by comparing the predicted output sequence to the composite target sequence. The loss function can be, for example, a cross-entropy loss function or a maximum-likelihood objective function that measures the discrepancy between the predicted probability distribution of the tokens and the actual tokens in the composite target sequence.

The optimization objective ensures the generative neural network learns to generate the beginning invisible token, the tokens representing intermediate data, the end invisible token, and the subsequent visible tokens in the correct order.

The system updates network parameters (step 312). The system updates the parameters of the generative neural network to optimize the objective function.

The system can update the parameters using any appropriate update technique, such as determining gradients of the objective function with respect to the parameters using a backpropagation technique and applying the gradients to the parameters using a gradient descent optimization algorithm (e.g., stochastic gradient descent, Adam, etc.).

The system can repeat steps 302-312 for multiple batches of training examples over multiple epochs until training criteria are satisfied, for example, until a fixed number of training iterations have been completed, or until the value of the objective function has satisfied a convergence threshold.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by a set of one or more computers, the method comprising:
receiving a network input;
processing the network input using a generative neural network to generate an output sequence of output tokens, wherein each output token is selected from a vocabulary of tokens that includes a plurality of visible tokens and one or more pairs of invisible tokens, each pair of invisible tokens comprising a respective beginning invisible token and a respective end invisible token;
processing the output sequence of output tokens to generate a final output sequence, comprising:
determining that the output sequence includes a beginning invisible token from one of the pairs followed by an end invisible token from the same pair; and
in response, removing, from the output sequence, the beginning invisible token, the end invisible token, and each visible token that is between the beginning invisible token and the end invisible token in the output sequence; and
providing the final output sequence in response to the network input.

2. The method of claim 1, wherein the generative neural network comprises an auto-regressive neural network that auto-regressively generates tokens from the vocabulary, and wherein the output sequence comprises visible tokens that are after the end invisible token in the output sequence and that are generated conditioned on the visible tokens that are between the beginning invisible token and the end invisible token in the output sequence.

3. The method of claim 1, wherein the visible tokens comprise text tokens that represent text data.

4. The method of claim 1, wherein the visible tokens comprise image tokens that represent image data.

5. The method of claim 1, wherein the visible tokens comprise audio tokens that represent audio data.

6. The method of claim 1, wherein:
the network input is received from a user device,
the set of one or more computers are remote from the user device, and
providing the final output sequence in response to the network input comprises providing the final output sequence to the user device.

7. The method of claim 6, wherein removing, from the output sequence, the beginning invisible token, the end invisible token, and each visible token that is between the beginning invisible token and the end invisible token in the output sequence is performed by the set of one or more computers prior to providing the final output sequence to the user device, such that the tokens between the beginning invisible token and the end invisible token are not transmitted to the user device.

8. The method of claim 1, wherein:
the network input is received as input from a user device,
the set of one or more computers includes only the user device, and
providing the final output sequence in response to the network input comprises providing the final output sequence for presentation on the user device.

9. The method of claim 1, wherein:
the set of one or more computers includes a server remote from a user device and the user device,
the server performs the processing of the network input using the generative neural network to generate the output sequence and transmits the output sequence to the user device, and
the user device performs the processing of the output sequence to generate the final output sequence by removing the beginning invisible token, the end invisible token, and each visible token that is between the beginning invisible token and the end invisible token.

10. The method of claim 1, wherein the network input comprises an initial prompt that characterizes a media item to be generated by the generative neural network, and wherein the tokens between the beginning invisible token and end invisible token represent an expanded prompt for generating the media item.

11. The method of claim 10, wherein the media item is an image, a video, or an audio sample.

12. The method of claim 11, wherein the generative neural network is configured to generate the media item conditioned on the tokens between the beginning invisible token and end invisible token, and wherein the method further comprises:
providing the media item in response to the network input.

13. The method of claim 1, wherein the network input comprises a query, wherein the tokens between the beginning invisible token and end invisible token represent intermediate data for generating a response to the query, and wherein the output sequence further comprises visible tokens that follow the end invisible token that represent the response to the query generated conditioned on the intermediate data.

14. The method of claim 13, wherein the network input further comprises an image or a video and the query is a query about the image or video.

15. The method of claim 14, wherein the intermediate data is grounding data specifying locations in the image or video of one or more objects.

16. The method of claim 13, wherein the intermediate data is a reasoning output.

17. The method of claim 1, wherein the vocabulary of tokens includes a plurality of distinct pairs of invisible tokens, and wherein removing, from the output sequence, the beginning invisible token, the end invisible token, and each visible token that is between the beginning invisible token and the end invisible token in the output sequence is performed according to a specific handling action determined based on an identity of the pair of invisible tokens included in the output sequence.

18. The method of claim 17, wherein the plurality of distinct pairs of invisible tokens includes a first pair associated with a first handling action and a second pair associated with a second handling action that is different from the first handling action.

19. A system comprising:
one or more computers; and
one or more storage devices communicatively coupled to the one or more computers, wherein the one or more storage devices store instructions that, when executed by the one or more computers, cause the one or more computers to perform operations, the operations comprising:
receiving a network input;
processing the network input using a generative neural network to generate an output sequence of output tokens, wherein each output token is selected from a vocabulary of tokens that includes a plurality of visible tokens and one or more pairs of invisible tokens, each pair of invisible tokens comprising a respective beginning invisible token and a respective end invisible token;
processing the output sequence of output tokens to generate a final output sequence, comprising:
determining that the output sequence includes a beginning invisible token from one of the pairs followed by an end invisible token from the same pair; and
in response, removing, from the output sequence, the beginning invisible token, the end invisible token, and each visible token that is between the beginning invisible token and the end invisible token in the output sequence; and
providing the final output sequence in response to the network input.

20. One or more non-transitory computer storage media storing instructions that when executed by one or more computers cause the one or more computers to perform operations, the operations comprising:
receiving a network input;
processing the network input using a generative neural network to generate an output sequence of output tokens, wherein each output token is selected from a vocabulary of tokens that includes a plurality of visible tokens and one or more pairs of invisible tokens, each pair of invisible tokens comprising a respective beginning invisible token and a respective end invisible token;
processing the output sequence of output tokens to generate a final output sequence, comprising:
determining that the output sequence includes a beginning invisible token from one of the pairs followed by an end invisible token from the same pair; and
in response, removing, from the output sequence, the beginning invisible token, the end invisible token, and each visible token that is between the beginning invisible token and the end invisible token in the output sequence; and
providing the final output sequence in response to the network input.
